(19) United States
(12) Patent Application Publication
(10) Pub. No.: US 2026/0204250 A1
(43) Pub. Date: Jul. 16, 2026

(54) NATURAL SPEECH GENERATION WITH INDEPENDENT CONDITIONING FOR AI SYSTEMS AND APPLICATIONS

(71) Applicant: NVIDIA CORPORATION, Santa Clara, CA (US)

(72) Inventors: Shehzeen Samarah Hussain, San Diego, CA (US); Paarth Neekhara, San Diego, CA (US); Jing Yao Li, Toronto (CA); Subhankar Ghosh, New York, NY (US)

(21) Appl. No.: 19/017,629

(22) Filed: Jan. 11, 2025

(51) Int. Cl. G10L 13/027

(52) U.S. Cl. CPC G10L 13/027

(57) ABSTRACT

In various examples, natural speech audio may be generated from transcript text and a representation of context such as an audio sample or text description of a target speaker. For example, a language model implemented using multiple non-autoregressive transformer encoders may be used to generate separate embeddings of transcript text and context, each of which may be applied to separate decoder layers to constrain cross-attention over the transcript text to be monotonic and leave cross-attention over the context unconstrained. In some embodiments, the language model may support multiple context encoders corresponding to different context modalities (e.g., an audio clip of a reference speaker, a textual description of a reference speaker, an audio clip of a conversation history), such that any supported context modality may be applied during deployment, and the appropriate context encoder may be activated and used to synthetize and output a corresponding speech waveform.

### BACKGROUND

Natural speech generation attempts to synthesize speech audio that replicates the nuances of human voice, including tone, intonation, rhythm, emotion, and context. Some natural speech generation techniques rely on language models to perform text-to-speech (TTS) synthesis using a short audio sample or text description of a target speaker - often referred to as a “speaker prompt”—which serves as a reference to model their voice, tone, and speaking style. Natural speech generation based on a speaker prompt facilitates the creation of personalized, expressive, and contextually appropriate audio outputs. There are many possible applications for this technology from personalized voice assistants to customer service tools, educational tools, and character animation, to name a few examples.

Some natural speech generation techniques use large language models (LLMs) implemented using autoregressive encoder-decoder transformer neural networks to synthesize speech from a transcript and using a speaker prompt to control the voice and style of the generated speech. However, conventional techniques have a variety of drawbacks. For example, some techniques use an encoder network to process a concatenated representation of the speaker prompt and the input transcript text or use a decoder network to process a concatenated representation of the speaker prompt and the autoregressive predicted speech. However, processing concatenated inputs limits the available context window and makes it challenging to independently learn meaningful representations for the transcript text, context, and output speech since the same network (encoder or decoder) is tasked with interpreting two different kinds of input.

Some techniques attempt to maintain a monotonic (sequential and aligned) relationship between the input transcript text and the output speech to avoid generating repeating words, missing words, or misaligned speech, but existing techniques have various limitations. More specifically, some existing natural speech generation models use a single non-autoregressive (NAR) transformer encoder with a single autoregressive (AR) transformer decoder architecture. In transformer-based models like these, cross-attention mechanisms are used to tell the decoder which parts of the encoder's output embedding to focus on when generating each speech token. Conventionally, embeddings for the transcript text and speaker prompt are concatenated, passed through the encoder, and applied to all the decoders layers. However, it is challenging to constrain the cross-attention to enforce monotonic alignment between the input transcript text and the output speech (e.g., so each input text segment aligns with a corresponding output speech segment) while leaving cross-attention over the speaker prompt to be unconstrained (e.g., so the entire speaker prompt gets considered for all output speech segments).

To simplify the monotonic alignment process, conventional techniques limit the input transcript text and speaker prompt embeddings to a fixed length so the matrix of cross-attention weights that define how the decoder attends to the concatenated embedding has a fixed size. This way, the matrix of cross-attention weights may be sliced or divided into a known portion that corresponds to the fixed-length input transcript text and a known portion that corresponds to the fixed-length speaker prompt, and the portion of the matrix of cross-attention weights corresponding to the transcript text may be constrained to be monotonic, leaving the portion corresponding to the speaker prompt unconstrained. However, using a fixed-length input context limits the amount of contextual information that can be provided to the language model (e.g., the length of the audio sample or text description of a target speaker). As a result, conventional techniques can truncate important information beyond the fixed-length context window, thereby losing context that is often important or necessary to generate accurate responses. In conversational settings, ongoing dialogue can be interrupted if the length of the conversation exceeds the fixed context length, resulting in less coherent and contextually aware interactions. Concatenating variable length contextual inputs can lead to variable length embeddings for different inferences, so it would not be possible to use a fixed slicing strategy to constrain cross-attention over just the input text embedding for all possible inputs, limiting the ability to parallelize different inferences.

As such, there is a need for improved natural speech generation.

### SUMMARY

Embodiments of the present disclosure relate to natural speech generation with independent conditioning for AI systems and applications. Systems and methods are disclosed that generate natural speech audio from transcript text and a representation of context such as an audio sample or text description of a target speaker. In contrast to conventional systems, a language model implemented using one or more non-autoregressive transformer encoders may be used to generate separate embeddings of transcript text and context, each of which may be applied to separate decoder layers to constrain cross-attention over the transcript text to be monotonic and leave cross-attention over the context unconstrained. In some embodiments, the language model may support multiple context encoders corresponding to different context modalities (e.g., an audio clip of a reference speaker, a textual description of a reference speaker, an audio clip of a conversation history, etc.), such that any supported context modality may be applied during deployment, and the appropriate context encoder may be activated and used to synthetize and output a corresponding speech waveform.

As such, the techniques described herein may be used to generate speech audio conditioned on input transcript text to be spoken and contextual input such as a speaker prompt or a sliding window of audio of a recent conversation. Using multiple encoders (e.g., multiple NAR transformer encoders) with a single autoregressive decoder transformer facilitates configuring the cross-attention layers of the decoder to attend to different encoder layer outputs. This allows the encoder to independently encode different conditioning inputs like transcript or speaker characteristics and easily constrain cross-attention layers in the decoder for monotonic transcript alignment without constraining the context length.

### BRIEF DESCRIPTION OF THE DRAWINGS

The present systems and methods for natural speech generation with independent conditioning for AI systems and applications are described in detail below with reference to the attached drawing figures, wherein:

FIG. 1 is a block diagram of an example speech generation system, in accordance with some embodiments of the present disclosure;

FIG. 2 is a block diagram of an example speech generation system with configurable context modalities, in accordance with some embodiments of the present disclosure;

FIG. 3 is a flow diagram illustrating a method for generating a representation of synthesized speech audio, in accordance with some embodiments of the present disclosure;

FIG. 4A is a block diagram of an example generative language model system suitable for use in implementing at least some embodiments of the present disclosure;

FIG. 4B is a block diagram of an example generative language model that includes a transformer encoder-decoder suitable for use in implementing at least some embodiments of the present disclosure;

FIG. 4C is a block diagram of an example generative language model that includes a decoder-only transformer architecture suitable for use in implementing at least some embodiments of the present disclosure;

FIG. 5 is a block diagram of an example computing device suitable for use in implementing at least some embodiments of the present disclosure; and

FIG. 6 is a block diagram of an example data center suitable for use in implementing at least some embodiments of the present disclosure.

### DETAILED DESCRIPTION

Systems and methods are disclosed relating to natural speech generation with independent conditioning for AI systems and applications. For example, a language model implemented using one or more non-autoregressive transformer encoders may be used to generate separate embeddings of transcript text and context, each of which may be applied to separate decoder layers to constrain cross-attention over the transcript text to be monotonic and leave cross-attention over the context unconstrained. In some embodiments, the language model may support multiple context encoders corresponding to different context modalities (e.g., an audio clip of a reference speaker, a textual description of a reference speaker, an audio clip of a conversation history, etc.), such that any supported context modality may be applied during deployment, and the appropriate context encoder may be activated and used to synthetize and output a corresponding speech waveform.

Implementing the language model using multiple encoders (e.g., multiple NAR transformer encoders) for the different conditioning inputs results in a variety of benefits. For example, this architecture uses independent networks for the input transcript text, context, and output speech, which allows each network to specialize in a particular task, thereby improving accuracy and generalization by focusing each network on domain-specific patterns. Furthermore, this architecture makes it easier to constrain the cross-attention over the input transcript text to be monotonic independent of the cross-attention over the context. More specifically, different encoders may be used to independently generate different conditioning embeddings (encoding different conditioning inputs like input transcript text or reference speaker characteristics), and the different conditioning embeddings may be applied to different decoder layers, such that the cross-attention in the different decoder layers may be configured and performed independently of one another. Moreover, using this multi-encoder architecture and applying the different conditioning embeddings to different decoder layers eliminates the need to slice the matrix of cross-attention weights into text and context portions. As a result, this architecture supports variable length contexts (not limited to fixed-length contexts) with monotonic attention biasing over the text input, since both context and text inputs may have separate cross-attention matrices. The use of variable length contexts facilitates the use of different types of context—such as audio clips and text descriptions—to condition the language model. This architecture also improves on prior techniques that applied the speaker prompt to the decoder because the context no longer uses up positional embeddings or part of the input sequence for the decoder.

In some embodiments, multiple context encoders may be used to process different context modalities. For example, depending on the training and/or deployment scenario, different types of contextual information may be available. Supported context encoders may include an encoder that processes an audio embedding of an audio clip of a reference speaker, an encoder that processes a text embedding of a textual description of a reference speaker, an encoder that processes an audio embedding of an audio clip of a conversation history (e.g., a sliding window of the last N seconds of a current conversation), and/or otherwise. A training dataset may be obtained or curated with scenarios representative of each of the supported context modalities. During training, depending on the applicable context modality in a given training example, the applicable context encoder may be selected and used to generate and apply a corresponding contextual embedding to the decoder, such that the decoder may be trained with different contextual encoders. As such, any or all of the supported context encoders may be deployed with the language model. In implementations that deploy multiple supported context encoders, an applicable context encoder may be user-selected or automatically detected based on the type of input data. As such, the appropriate context encoder may be activated and used to synthetize and output a corresponding speech waveform.

As such, the techniques described herein may be used to generate speech audio conditioned on input transcript text to be spoken and contextual input such as a speaker prompt or a sliding window of audio of a recent conversation. Using multiple encoders (e.g., multiple NAR transformer encoders) with a single autoregressive decoder transformer facilitates configuring the cross-attention layers of the decoder to attend to different encoder layer outputs. This allows the encoder to independently encode different conditioning inputs like transcript or speaker characteristics and easily constrain cross-attention layers in the decoder for monotonic transcript alignment without constraining the context length.

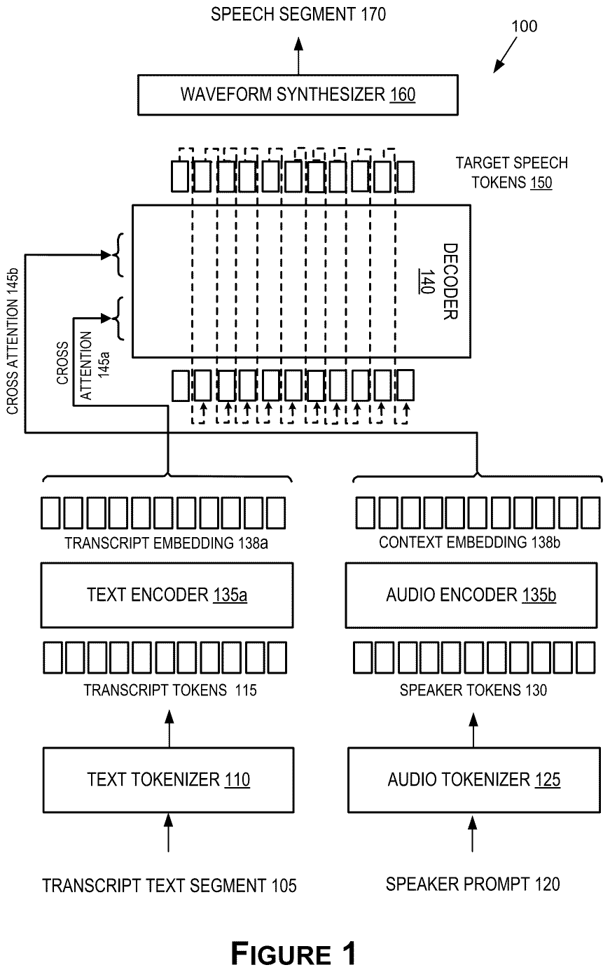

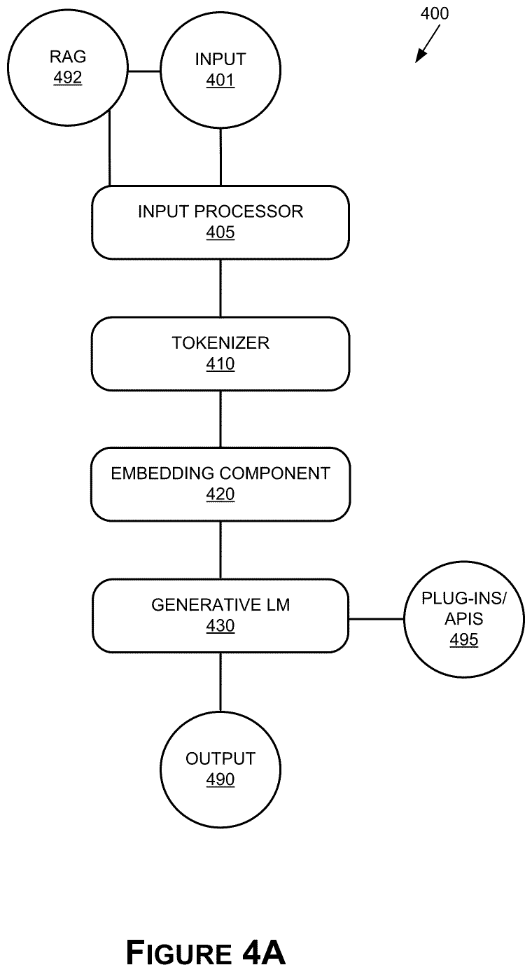

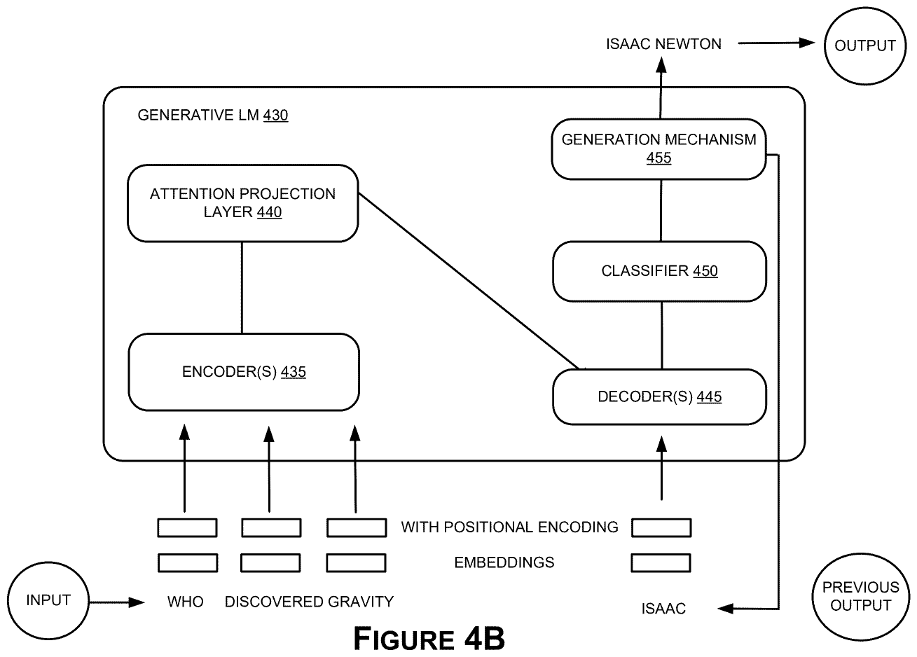

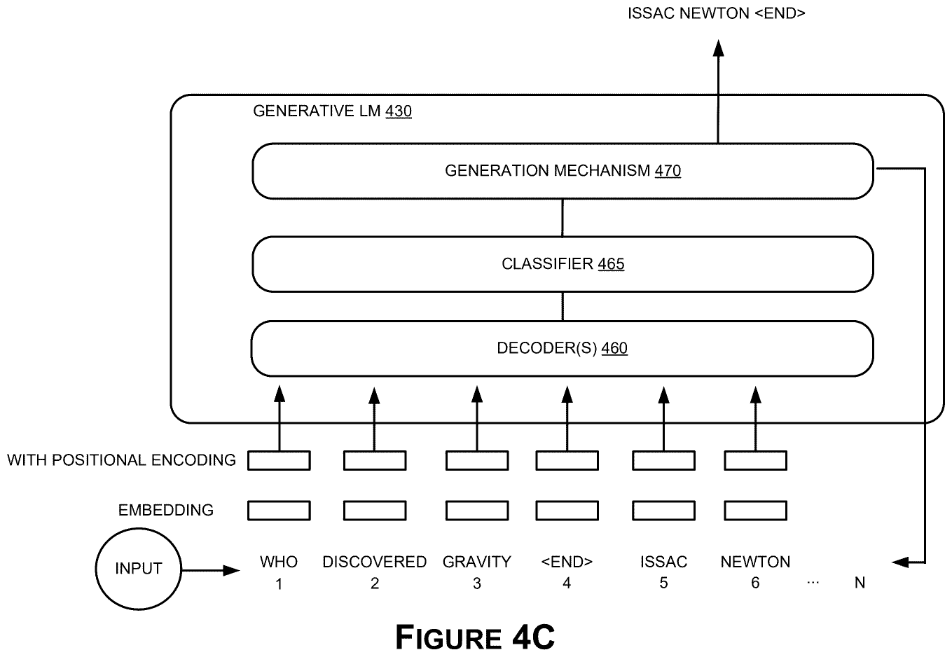

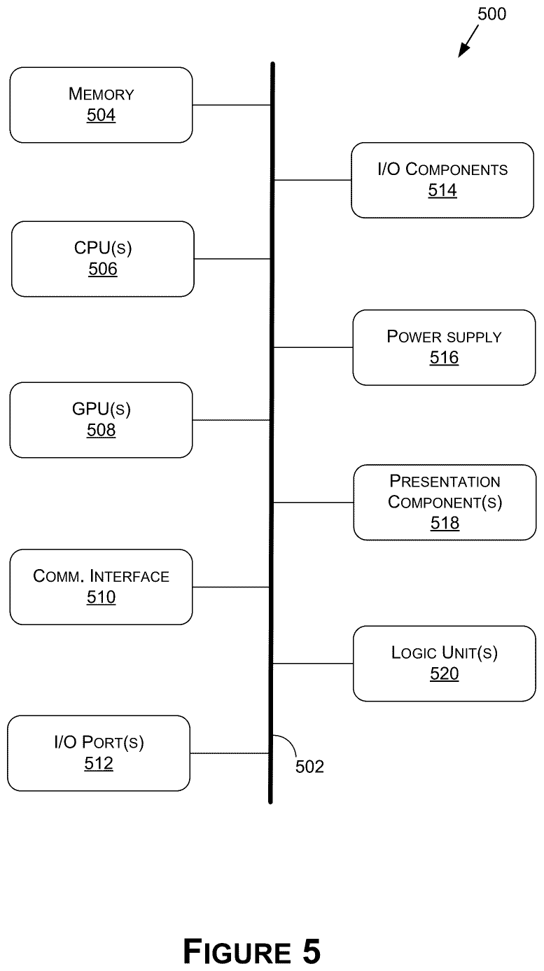

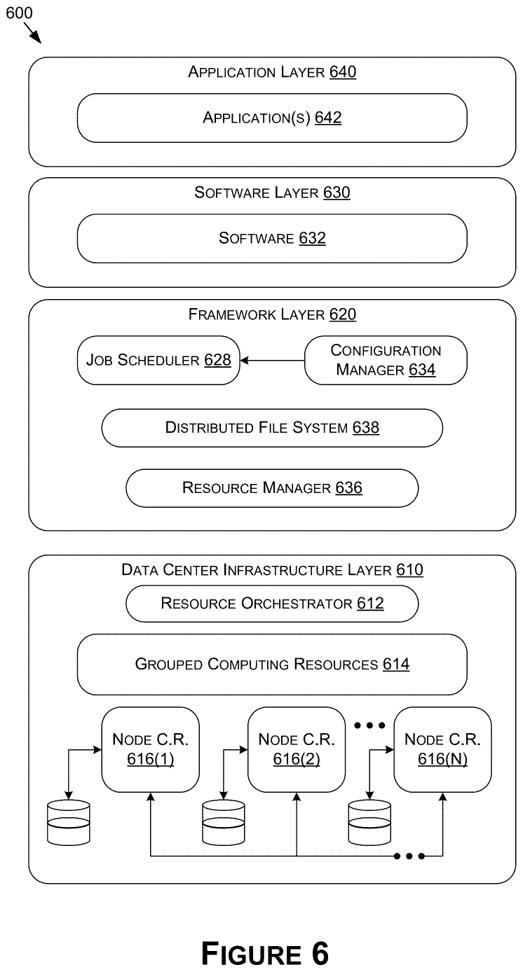

With reference to FIG. 1, FIG. 1 is an example speech generation system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. In some embodiments, the system and methods described herein may be implemented using one or more generative language models (e.g., as described in FIGS. 4A-4C), one or more computing devices or components thereof (e.g., as described in FIG. 5), and/or one or more data centers or components thereof (e.g., as described in FIG. 6).

Depending on the implementation, the speech generation system 100 and/or other systems and components described herein may be implemented using machine learning model(s), and the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

At a high level, the speech generation system 100 illustrated in FIG. 1 may be used to generate natural speech (e.g., speech segment 170) from transcript text (e.g., transcript text segment 105) and an audio sample or text description of a target or reference speaker (e.g., speaker prompt 120). The speech generation system 100 may be used to synthesize speech for a variety of applications, such as voice assistants or automated customer service tools (e.g., converting text responses into synthesized speech), character animation (e.g., creating synthetic voices for scripted gaming, virtual reality, or animated characters), content creation (e.g., dubbing videos or podcasts with synthesized speech), personalized media experiences (e.g., using personalized voices for instructions or narrations), generation of (e.g., multi-speaker, multi-lingual) speech dialogues (e.g. to simulate interviews, multi-speaker podcasts, sports commentary, advertisements, etc.), to name a few examples. Depending on the application, any known technique may be used to identify a corresponding transcript text segment 105 (e.g., segmenting a script or generated text response into fixed or variable length text segments) and a corresponding speaker prompt 120 (e.g., a variable or fixed length prompt, a user-specified speaker prompt, a speaker prompt tailored to a corresponding character, a speaker prompt tailored to an applicable scenario, a speaker prompt specifying a desired emotional tone or stylistic effect, etc.), and the transcript text segment 105 and speaker prompt 120 may be provided as input to the speech generation system 100. Note that FIG. 1 illustrates an example implementation in which the speaker prompt 120 takes the form of an audio sample, but this need not be the case. For example, in embodiments in which the speaker prompt 120 takes the form of a text description (or some other form), the audio tokenizer 125 and audio encoder 135b may be replaced with a corresponding text (or other type of) tokenizer and encoder.

In the example illustrated in FIG. 1, the speech generation system 100 includes a text tokenizer 110, an audio tokenizer 125, a text encoder 135a, an audio encoder 135b, a decoder 140, and a waveform synthesizer 160. Collectively, some or all of the speech generation system 100 may be considered to form a multi-modal language model (e.g., which may correspond to the example generative language model system 400 of FIGS. 4A-4C) that accepts input text (e.g., the transcript text segment 105, the speaker prompt 120 in embodiments in which the speaker prompt 120 takes the form of a text description) and input audio (e.g., in embodiments in which the speaker prompt 120 takes the form of an audio sample) and outputs a representation of synthesized audio (e.g., the target speech tokens 150 and/or the speech segment 170).

The text tokenizer 110 may use any known technique to tokenize the transcript text segment 105 and generate a sequence of transcript tokens 115 (such as the techniques described below with respect to tokenizer 410 of FIG. 4A, SentencePiece tokenization, phoneme tokenization, etc.), and the transcript tokens 115 may be applied to the text encoder 135a. In the example illustrated in FIG. 1, the audio tokenizer 125 may use any known technique to encode or discretize the speaker prompt 120 into a sequence of speaker tokens 130 (such as the techniques described below with respect to tokenizer 410 of FIG. 4A). In some embodiments, the audio tokenizer 125 uses an audio encoder, such as the encoder portion of an acoustic codec model (e.g., a neural audio codec like EnCodec), to compress audio into a sequence of discrete units (audio codes) quantizing the features of the input speech signal in the speaker prompt 120 with a corresponding codebook. For example, the encoder of the acoustic codec model may map segments of the speaker prompt 120 to corresponding entries in the codebook, producing a sequence of discrete codes that may be used as the speaker tokens 130. In some embodiments, the audio tokenizer 125 may implement an audio encoder using some other machine learning or signal processing technique, such as spectrogram quantization (e.g., extracting features such as Mel-frequency bands or log-Mel spectrograms from raw audio and discretizing the resulting features into corresponding speaker tokens 130). As such, the speaker tokens 130 may be applied to the audio encoder 135b.

In the embodiment illustrated in FIG. 1, the text encoder 135a extracts a transcript embedding 138a from the transcript tokens 115, the audio encoder 135b extracts a context embedding 138b from the speaker tokens 130, and the decoder 140 uses the transcript embedding 138a and context embedding 138b to extract target speech tokens 150. In this example, the text encoder 135a and the audio encoder 135b are independent encoders, each of which may be implemented with a corresponding non-autoregressive bi-directional transformer encoder, and the decoder 140 may be implemented with an autoregressive transformer.

More specifically, each of the encoders (the text encoder 135a and the audio encoder 135b) may pass its corresponding input (transcript tokens and speaker tokens, respectively) through an embedding layer to convert tokens into dense vector representations, combine these embeddings with positional encodings to provide information about the order of tokens in the sequence, and pass these embeddings through any number of transformer encoder layers (e.g., comprising self-attention mechanisms and feed-forward networks). The decoder 140 may pass input tokens (e.g., a start-of-sequence token or a previously generated portion of the target speech tokens 150) through an embedding layer to convert them into dense vector representations, combine these embeddings with positional encodings to incorporate token order, and pass these embeddings through any number of transformer decoder layers. For example, each decoder layer may apply self-attention (e.g., in which tokens attend to themselves and earlier tokens in the sequence, in embodiments that implement an autoregressive transformer) and cross-attention (e.g., incorporating information from the transcript embedding 138a and the context embedding 138b). The last layer's output may be passed through a linear layer and a softmax function to predict the next token, which may be appended to the previously generated portion of the target speech tokens 150, and the process may repeat until the sequence of target speech tokens 150 is complete.

In this example, the transcript embedding 138a and context embedding 138b may be applied to different decoder layers, such that the cross-attention in the different decoder layers may be configured and performed independently of one another. Which decoder layer(s) the transcript embedding 138a is applied to and which decoder layer(s) the context embedding 138b is applied to may depend on the implementation. For example, the transcript embedding 138a and the context embedding 138b may be interleaved or alternate across successive decoder layers (e.g., by applying one of the embeddings to decoder layers 1, 3, 5, 7, etc. and applying the other embedding to decoder layers 2, 4, 6, 8, etc.), may be interleaved or alternate across sets of consecutive decoder layers (e.g., by applying one of the embeddings to decoder layers 1-2, 5-6, etc. and the other one to decoder layers 3-4, 7-8, etc.), may be applied in any suitable order, may but need not be applied to the same (or approximately the same) number of decoder layers, etc. This way, the decoder 140 may constrain cross-attention 145a over the transcript embedding 138a to be monotonic and leave cross-attention 145b over the context embedding 138b unconstrained. Any known technique may be used to constrain the cross-attention 145a to be monotonic. For example, an attention prior may be used to guide the cross-attention 145 weights to follow a diagonal pattern, encouraging the attention mechanism used in corresponding layers of the decoder 140 to focus sequentially on the transcript tokens 115 in the correct order.

As such, the decoder 140 may generate target speech tokens 150 representing a synthesized voice speaking the transcript text segment 105 using the context provided in the speaker prompt 120, and the waveform synthesizer 160 may convert the target speech tokens 150 into a corresponding speech segment 170 using any known technique to transform the target speech tokens 150 into a continuous audio waveform. For example, the target speech tokens 150 (e.g., audio codes or acoustic representations) may be applied to an audio decoder implemented using one or more neural networks (e.g., a neural vocoder such as WaveNet or HiFi-GAN, the decoder component of a neural codec model like EnCodec, etc.) that map the token sequence to a high-resolution audio waveform. The waveform synthesizer 160 may process the target speech tokens 150 sequentially or in parallel and may apply smoothing to transitions between frames to generate a continuous speech waveform. Depending on the application, the resulting speech segment 170 may be played back on a speaker, recorded for future playback or processing, and/or otherwise.

Generally, any known technique may be used to train the natural speech generation system 100 to generate speech for any speaker, accent, language, etc. By way of nonlimiting example, the text tokenizer 110, the audio tokenizer 125, and/or the waveform synthesizer 160 may be implemented using pre-trained and/or off-the-shelf models, and depending on the available training data, the language model formed by the text encoder 135a, the audio encoder 135b, and the decoder 140 may be trained as part of the natural speech generation system 100, keeping the text tokenizer 110, the audio tokenizer 125, and/or the waveform synthesizer 160 fixed or frozen. In some embodiments, the training process may jointly train the text encoder 135a, audio encoder 135b, and decoder 140, and may minimize a loss function such as cross-entropy loss to encourage the decoder 140 to generate speech tokens in the correct order. To improve the alignment between the text input and speech output, an alignment loss may be used to penalize deviations from monotonic alignment in decoder layers that process the transcript embedding 138a, encouraging the decoder 140 to produce speech outputs that correspond to the input text sequence. The training process may include fine-tuning on task-specific datasets, which may depend on the application and/or embodiment. These are just a few examples, and other suitable training techniques may be implemented within the scope of the present disclosure.

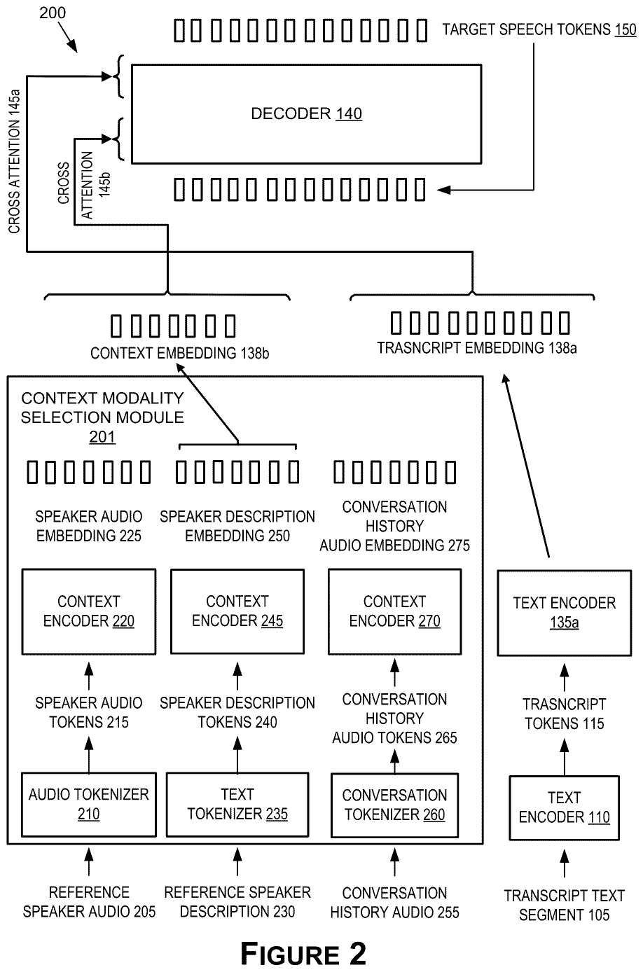

FIG. 2 is a block diagram of an example speech generation system 200 with configurable context modalities, in accordance with some embodiments of the present disclosure. More specifically, FIG. 2 represents a variation of the speech generation system 100 of FIG. 1 that includes multiple supported context encoders (context encoders 220, 245, and 270) corresponding to different context modalities (e.g., an audio clip of a reference speaker represented by the reference speaker audio 205, a textual description of a reference speaker represented by the reference speaker description 230, an audio clip of a conversation history represented by the conversation history audio 255), such that any supported context modality input may be applied, and a context modality selection module 201 may activate and use an appropriate context encoder to generate a corresponding context embedding 138b. The components in FIG. 2 with the same reference numbers as in FIG. 1 may operate in a similar manner.

By way of motivation, different types of contextual information may be useful in different scenarios. For example, a speaker prompt in the form of a reference audio clip of a reference speaker may be useful for voice cloning or speaker style transfer (e.g., in applications such as personalized text-to-speech systems or creating consistent character voices). A speaker prompt in the form of a text description of a reference speaker may be useful for synthetic voice creation when specifying desired attributes (e.g., gender, accent, tone) without an actual audio sample (e.g., in applications such as virtual assistants or gaming). An audio clip of (e.g., the last few seconds of) a current conversation may be useful in real-time communication systems such as conversational AI or voice assistants where the system attempts to maintain a consistent vocal delivery. In some (e.g., training, development, or deployment) scenarios, it may be useful to support multiple types of contextual information. For example, a developer may want to use the same language model for different tasks or may want to use different types of contextual information in different scenarios.

As such, the speech generation system 200 may include multiple supported context encoders (context encoders 220, 245, and 270). For example, the speech generation system 200 may include an audio tokenizer 210 that uses any known technique to encode or discretize reference speaker audio 205 into a sequence of speaker audio tokens 215 (such as the techniques described above with respect to the audio tokenizer 125 of FIG. 1) and a context encoder 220 that uses any known technique to extract a speaker audio embedding 225 from the speaker audio tokens 215 (such as the techniques described above with respect to the audio encoder 135b of FIG. 1). Additionally or alternatively, the speech generation system 200 may include a text tokenizer 235 that uses any known technique to tokenize a reference speaker description 230 into corresponding speaker description tokens 240 (such as the techniques described above with respect to the text tokenizer 110 of FIG. 1) and a context encoder 245 that uses any known technique to extract a speaker description embedding 250 from the speaker description tokens 240 (such as the techniques described above with respect to the text encoder 135a of FIG. 1).

Additionally or alternatively, the speech generation system 200 may include a conversation tokenizer 260 that uses any known technique to generate or extract an audio clip (e.g., the conversation history audio 255) of a recent conversation (e.g., from a sliding window of the last N seconds, minutes, hours, etc. of a current conversation, such as the last 30 seconds) and any known technique to encode or discretize the conversation history audio 255 into a sequence of conversation history audio tokens 265 (such as the techniques described above with respect to the audio tokenizer 125 of FIG. 1), and may include a context encoder 270 that uses any known technique to extract a conversation history audio embedding 275 from the conversation history audio tokens 265 (such as the techniques described above with respect to the audio encoder 135b of FIG. 1). This path may be used to continue the style of an ongoing or previous conversation, using an audio segment of the existing conversation to generate a subsequent audio segment conditioned on how one or more participants in the conversation were talking.

As such, the context modality selection module 201 may activate a corresponding path (e.g., in response to a corresponding user-selected command, API call or input channel used to provide the contextual input, or some other feature that identifies the type of contextual input), may use that path to generate a corresponding embedding and use that embedding as the context embedding 138b. As such, the decoder 140 may operate as described above with respect to FIG. 1 to generate target speech tokens 150, and the waveform synthesizer 160 of FIG. 1 (not illustrated in FIG. 2) may be used to generate a corresponding speech segment 170. Note in the example in FIG. 2, the ordering of the decoder layers that perform the cross-attention 145a and 145b is illustrated differently than in FIG. 1 to represent some possible variations.

The speech generation system 200 may be trained using similar techniques as described above with respect to the speech generation system 100 of FIG. 1, and the decoder 140 may be trained to handle multiple types of contextual information. For example, a training dataset may be identified or curated with examples that use the different types of contextual information (e.g., input training data comprising a transcript text segment 105 and one of the supported contextual inputs such as reference speaker audio 205, a reference speaker description 230, or conversation history audio 255, paired with corresponding ground truth target speech tokens 150 and/or a ground truth speech segment 170). For example, the training dataset may include input training data comprising paired text transcripts and reference speaker audio clips/text descriptions, and ground truth training data comprising corresponding audio recordings of speech that match the text transcripts and reflect the vocal characteristics of the reference speaker. Taking conversation history audio as an example, training data may be generated from audio or video libraries or repositories, and may include examples where one participant is instructing another participant to use a particular speaking style (e.g., tone, pitch, pace, emotion, etc.). In some such examples, the training dataset may include input training data comprising paired text transcripts and audio clips of conversations (e.g., instructing speaking style), and ground truth training data comprising corresponding audio recordings (e.g., of the participant's response using the instructed speaking style). As such, depending on the applicable example in the training dataset, the context modality selection module 201 may activate a corresponding path and train the decoder 140 with a corresponding encoder over any number of training examples.

As such, any or all of the supported input paths and context encoders may be deployed with the speech generation system 200. Accordingly, any of the supported types of contextual inputs may be applied to the speech generation system 200, and the context modality selection module 201 may activate a corresponding path and use that path to process a corresponding contextual input and synthesized speech. Having multiple supported context encoders provides increased flexibility in speech generation.

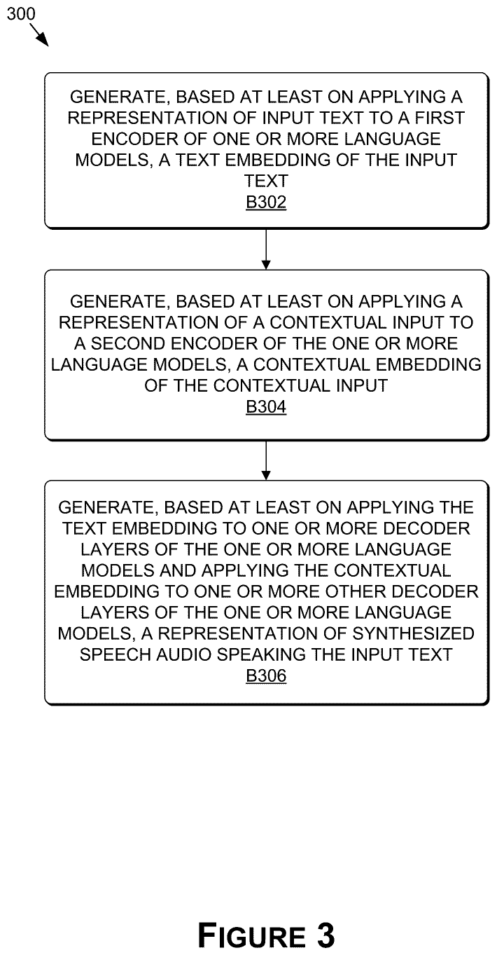

Now referring to FIG. 3, each block of method 300, described herein, comprises a computing process that may be performed using any combination of hardware, firmware, and/or software. For instance, various functions may be carried out using one or more processors executing instructions stored in one or more memories. The method 300 may also be embodied as computer-usable instructions stored on computer storage media. The method 300 may be provided by a standalone application, a service or hosted service (standalone or in combination with another hosted service), as a microservice via an application programming interface (API) or a plug-in to another product, to name a few. In addition, the method 300 is described, by way of example, with respect to the speech generation system 100 of FIG. 1. However, this method may additionally or alternatively be executed by any one system, or any combination of systems, including, but not limited to, those described herein.

FIG. 3 is a flow diagram illustrating a method 300 for generating a representation of synthesized speech audio, in accordance with some embodiments of the present disclosure. The method 300, at block B302, includes generating, based at least on applying a representation of input text to a first encoder of one or more language models, a text embedding of the input text. For example, with respect to the speech generation system 100 of FIG. 1, the text tokenizer 110 may use any known technique to tokenize the transcript text segment 105 and generate a sequence of transcript tokens 115, the transcript tokens 115 may be applied to the text encoder 135a, and the text encoder 135a (e.g., non-autoregressive bi-directional transformer encoder) may extract a transcript embedding 138a from the transcript tokens 115.

The method 300, at block B304, includes generating, based at least on applying a representation of a contextual input to a second encoder of the one or more language models, a contextual embedding of the contextual input. For example, with respect to the speech generation system 100 of FIG. 1, the audio tokenizer 125 may use any known technique to encode or discretize the speaker prompt 120 into a sequence of speaker tokens 130, the speaker tokens 130 may be applied to the audio encoder 135b, and the audio encoder 135b may extract a context embedding 138b from the speaker tokens 130. In embodiments in which the speaker prompt 120 takes the form of a text description, the audio tokenizer 125 and audio encoder 135b may be replaced with a corresponding text tokenizer and encoder. With respect to the speech generation system 200 of FIG. 2, any supported context modality input (e.g., the reference speaker audio 205, the reference speaker description 230, the conversation history audio 255) may be applied, and the context modality selection module 201 may activate a corresponding path (e.g., based on a corresponding user-selected command, API call or input channel used to provide the contextual input, or some other feature that identifies the contextual input), use that path to generate a corresponding embedding, and use the embedding as the context embedding 138b.

The method 300, at block B306, includes generating, based at least on applying the text embedding to one or more decoder layers of the one or more language models and applying the contextual embedding to one or more other decoder layers of the one or more language models, a representation of synthesized speech audio speaking the input text. For example, with respect to the speech generation system 100 of FIG. 1, the decoder 140 may use the transcript embedding 138a and context embedding 138b to extract target speech tokens 150. The transcript embedding 138a and context embedding 138b may be applied to different decoder layers, such that the cross-attention in the different decoder layers may be configured and performed independently of one another. For example, the transcript embedding 138a and the context embedding 138b may be interleaved or alternate across successive decoder layers (e.g., by applying one of the embeddings to decoder layers 1, 3, 5, 7, etc. and applying the other embedding to decoder layers 2, 4, 6, 8, etc.), may be interleaved or alternate across sets of consecutive decoder layers (e.g., by applying one of the embeddings to decoder layers 1-2, 5-6, etc. and the other one to decoder layers 3-4, 7-8, etc.), may but need not apply the embeddings to the same (or approximately the same) number of decoder layers, etc. As such, the decoder 140 may generate target speech tokens 150 representing a synthesized voice speaking the transcript text segment 105 using the context provided in the speaker prompt 120, and the waveform synthesizer 160 may convert the target speech tokens 150 into a corresponding speech segment 170 using any known technique to transform the target speech tokens 150 into a continuous audio waveform.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

In some embodiments, the systems and methods described herein may be performed to synthesize speech within a simulation environment (e.g., NVIDIA Omniverse, NVIDIA DriveSIM). For example, one or more language models may be used to synthesize speech for one or more simulated agents in the simulation environment. Depending on the scenario or implementation, the synthesized speech may be played back and used as a synthesized voice for the simulated agent(s) such that the simulated agent(s) engage in conversation, narrate one or more events, provide one or more instructions, or respond to one or more user actions within the simulation. For example, input text (e.g., one or more pre-written scripts, one or more responses to one or more events, or one or more contextual instructions corresponding to a state of the simulation) and a contextual input (e.g., a speaker prompt, a conversation history within the simulation) may be applied to a speech generation system comprising a language model (e.g., the speech generation system 100 of FIG. 1, the speech generation system 200 of FIG. 2) to synthesize and playback any number of speech segments (e.g., within the simulation, via one or more speakers audible to one or more users interacting with the simulation, etc.). These simulated operations may be used to test performance of the underlying algorithms, systems, and/or processes prior to deploying them in the real-world. In some instances, the simulation may be used to generate synthetic training data—e.g., simulated speech, a simulated conversation, etc.—and the synthetic training data (in addition or as an alternative to real-world data) may be used to train a language model. In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

In some embodiments, the system and methods described herein may be deployed in a talking or smart kiosk application. For example, a kiosk, tablet, smart display, or other device may include one or more onboard processors (e.g., CPUs, GPUs, deep learning accelerators, SoCs) and memory and/or storage (e.g., for storing the model, the image database, etc.). In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with the machine learning model(s) (e.g., language model, LLM, VLM, MMLM, diffusion model, transformer model, NeRF, DNN, etc.) and/or the image database hosted on the local and/or remote servers using one or more APIs—such as, without limitation, REST APIs.

In one or more embodiments, the system and methods described herein may be deployed in a gaming application. For example, a gaming console, PC, tablet, or other gaming device may include one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., diffusion models, transformer models, neural rendering field (NeRF) models, language models (e.g., LLMs, VLMs, MMLMs, etc.), DNNs, etc.) to enhance gameplay, generate real-time dynamic content, and personalize user experiences based on in-game behavior or pre-stored player profiles. In some embodiments, the system may be deployed in a cloud gaming environment (e.g., NVIDIA's GeFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used.

In some embodiments, the system and methods described herein may be deployed in a video conferencing application. For example, a video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). The system may use the machine learning model(s) (e.g., diffusion models, transformer models, neural rendering field (NeRF) models, language models (e.g., LLMs, VLMs, MMLMs, etc.)) to enhance video conferencing functionality, including real-time or near real-time transcription, diarization, language translation, automatic speech recognition (ASR), and/or background noise reduction. In one or more embodiments, the system may enable users to interact with the video conferencing platform using natural language inputs. For example, users may issue voice commands to schedule, join, or leave meetings, or to manage participants and screen sharing. During receiving and/or sending the data to and from the end-user or edge device(s), one or more data processing units (DPUs) and/or network interface cards (NICs) may be used.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)-which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)-which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

In some embodiments, one or more transformer engines (TEs) may be implemented. The transformer engine may use micro-tensor scaling to optimize performance and accuracy—such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using NVLink Switch) and tensor cores (which enable mixed-precision computing, such as microscaling precision support), server clusters may be more capable of training enormous networks at high speeds. As such, tensor core precisions of FP64, TF32, BF16, FP16, FP8, INT8, FP6, and FP4 may be supported, as well as CUDA core precisions of FP64, FP32, FP16, and BF16.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases) - such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 4A is a block diagram of an example generative language model system 400 suitable for use in implementing at least some embodiments of the present disclosure. In the example illustrated in FIG. 4A, the generative language model system 400 includes a retrieval augmented generation (RAG) component 492, an input processor 405, a tokenizer 410, an embedding component 420, plug-ins/APIs 495, and a generative language model (LM) 430 (which may include an LLM, a VLM, a multi-modal LM, etc.).

At a high level, the input processor 405 may receive an input 401 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 430 (e.g., LLM/VLM/MMLM/etc.). In some embodiments, the input 401 includes plain text in the form of one or more sentences, paragraphs, and/or documents. Additionally or alternatively, the input 401 may include numerical sequences, precomputed embeddings (e.g., word or sentence embeddings), and/or structured data (e.g., in tabular formats, JSON, or XML). In some implementations in which the generative LM 430 is capable of processing multi-modal inputs, the input 401 may combine text (or may omit text) with image data, audio data, video data, design data, USD data, and/or other types of input data, such as but not limited to those described herein. Taking raw input text as an example, the input processor 405 may prepare raw input text in various ways. For example, the input processor 405 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 405 may remove stopwords to reduce noise and focus the generative LM 430 on more meaningful content. The input processor 405 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 492 (which may include one or more RAG models, and/or may be performed using the generative LM 430 itself) may be used to retrieve additional information to be used as part of the input 401 or prompt. RAG may be used to enhance the input to the LLM/VLM/MMLM/etc. with external knowledge, so that answers to specific questions or queries or requests are more relevant—such as in a case where specific knowledge is required. The RAG component 492 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 401 may be generated using the query or input to the model (e.g., a question, a request, etc.) in addition to data retrieved using the RAG component 492. In some embodiments, the input processor 405 may analyze the input 401 and communicate with the RAG component 492 (or the RAG component 492 may be part of the input processor 405, in embodiments) in order to identify relevant text and/or other data to provide to the generative LM 430 as additional context or sources of information from which to identify the response, answer, or output 490, generally. For example, where the input indicates that the user is interested in a desired tire pressure for a particular make and model of vehicle, the RAG component 492 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 492 may retrieve a prior stored conversation history—or at least a summary thereof—and include the prior conversation history along with the current ask/request as part of the input 401 to the generative LM 430.

The RAG component 492 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 492 and the embeddings of the chunks along with the embeddings of the query may be compared to identify the most similar/related embeddings to the query, which may be supplied to the generative LM 430 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 492 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 410 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 430 to understand morphological variations and handle out-of-vocabulary words more effectively. Character-based tokenization represents each character as a separate token, enabling the generative LM 430 to process text at a fine-grained level. The choice of tokenization strategy may depend on factors such as the language being processed, the task at hand, and/or characteristics of the training dataset. As such, the tokenizer 410 may convert the (e.g., processed) text into a structured format according to tokenization schema being implemented in the particular embodiment.

The embedding component 420 may use any known embedding technique to transform discrete tokens into (e.g., dense, continuous vector) representations of semantic meaning. For example, the embedding component 420 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 401 includes image data/video data/etc., the input processor 401 may resize the data to a standard size compatible with format of a corresponding input channel and/or may normalize pixel values to a common range (e.g., 0 to 1) to ensure a consistent representation, and the embedding component 420 may encode the image data using any known technique (e.g., using one or more convolutional neural networks (CNNs) to extract visual features). In some implementations in which the input 401 includes audio data, the input processor 401 may resample an audio file to a consistent sampling rate for uniform processing, and the embedding component 420 may use any known technique to extract and encode audio features—such as in the form of a spectrogram (e.g., a mel-spectrogram). In some implementations in which the input 401 includes video data, the input processor 401 may extract frames or apply resizing to extracted frames, and the embedding component 420 may extract features such as optical flow embeddings or video embeddings and/or may encode temporal information or sequences of frames. In some implementations in which the input 401 includes multi-modal data, the embedding component 420 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 430 and/or other components of the generative LM system 400 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 420 may apply an encoded representation of the input 401 to the generative LM 430, and the generative LM 430 may process the encoded representation of the input 401 to generate an output 490, which may include responsive text and/or other types of data.

As described herein, in some embodiments, the generative LM 430 may be configured to access or use—or capable of accessing or using—plug-ins/APIs 495 (which may include one or more plug-ins, application programming interfaces (APIs), databases, data stores, repositories, etc.). For example, for certain tasks or operations that the generative LM 430 is not ideally suited for, the model may have instructions (e.g., as a result of training, and/or based on instructions in a given prompt, such as those retrieved using the RAG component 492) to access one or more plug-ins/APIs 495 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 495 to the plug-in/API 495, the plug-in/API 495 may process the information and return an answer to the generative LM 430, and the generative LM 430 may use the response to generate the output 490. This process may be repeated—e.g., recursively—for any number of iterations and using any number of plug-ins/APIs 495 until an output 490 that addresses each ask/question/request/process/operation/etc. from the input 401 can be generated. As such, the model(s) may not only rely on its own knowledge from training on a large dataset(s) and/or from data retrieved using the RAG component 492, but also on the expertise or optimized nature of one or more external resources—such as the plug-ins/APIs 495.

FIG. 4B is a block diagram of an example implementation in which the generative LM 430 includes a transformer encoder-decoder. For example, assume input text such as “Who discovered gravity” is tokenized (e.g., by the tokenizer 410 of FIG. 4A) into tokens such as words, and each token is encoded (e.g., by the embedding component 420 of FIG. 94A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 435 of the generative LM 430.

In an example implementation, the encoder(s) 435 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 440 may convert the context vector into attention vectors (keys and values) for the decoder(s) 445.

In an example implementation, the decoder(s) 445 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 435, in an example transformer architecture, each token (e.g., word) flows through a separate path in the decoder(s) 445. During a first pass, the decoder(s) 445, a classifier 450, and a generation mechanism 455 may generate a first token, and the generation mechanism 455 may apply the generated token as an input during a second pass. The process may repeat in a loop, successively generating and adding tokens (e.g., words) to the output from the preceding pass and applying the token embeddings of the composite sequence with positional encodings as an input to the decoder(s) 445 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 435, except that it creates its queries from the layer below it and takes the keys and values (e.g., matrix) from the output of the encoder(s) 435.

As such, the decoder(s) 445 may output some decoded (e.g., vector) representation of the input being applied during a particular pass. The classifier 450 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 455 may select or sample a word or token based on a corresponding predicted probability (e.g., select the word with the highest predicted probability) and append it to the output from a previous pass, generating each word or token sequentially. The generation mechanism 455 may repeat the process, triggering successive decoder inputs and corresponding predictions until selecting or sampling a symbol or token that represents the end of the response, at which point, the generation mechanism 455 may output the generated response.

FIG. 4C is a block diagram of an example implementation in which the generative LM 430 includes a decoder-only transformer architecture. For example, the decoder(s) 460 of FIG. 4C may operate similarly as the decoder(s) 445 of FIG. 4B except each of the decoder(s) 460 of FIG. 4C omits the encoder-decoder self-attention layer (since there is no encoder in this implementation). As such, the decoder(s) 460 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 460. As with the decoder(s) 445 of FIG. 4B, each token (e.g., word) may flow through a separate path in the decoder(s) 460, and the decoder(s) 460, a classifier 465, and a generation mechanism 470 may use auto-regression to sequentially generate one token at a time until predicting a symbol or token that represents the end of the response. The classifier 465 and the generation mechanism 470 may operate similarly as the classifier 450 and the generation mechanism 455 of FIG. 4B, with the generation mechanism 470 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). As such, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system). Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506) and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that allow the computing device 500 to communicate with other computing devices via an electronic communication network, included wired and/or wireless communications. The communication interface 510 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may allow the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that allow detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to allow the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

### Example Data Center

FIG. 6 illustrates an example data center 600 that may be used in at least one embodiments of the present disclosure. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-6161(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark^{TM} (hereinafter “Spark”) that may use distributed file system 638 for large-scale data processing (e.g., “big data”). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
generate, based at least on applying a representation of input text to a first encoder of one or more language models, a text embedding of the input text;
generate, based at least on applying a representation of a contextual input to a second encoder of the one or more language models, a contextual embedding of the contextual input; and
generate, based at least on applying the text embedding to one or more first decoder layers of the one or more language models and applying the contextual embedding to one or more second decoder layers of the one or more language models, a representation of synthesized speech audio speaking the input text.

2. The one or more processors of claim 1, wherein the processing circuitry is further to cross-attend over the text embedding in the one or more first decoder layers independent of cross-attending over the contextual embedding in the one or more second decoder layers.

3. The one or more processors of claim 1, wherein the processing circuitry is further to constrain cross-attention over the text embedding in the one or more first decoder layers without constraining cross-attention over the contextual embedding in the one or more second decoder layers.

4. The one or more processors of claim 1, wherein the processing circuitry is further to alternate between applying the text embedding and applying the contextual embedding to successive sets of decoder layers of the one or more language models.

5. The one or more processors of claim 1, wherein the processing circuitry is further to interleave the text embedding and the contextual embedding across successive decoder layers of the one or more language models.

6. The one or more processors of claim 1, wherein the one or more language models comprise multiple non-autoregressive transformer encoders and a single transformer decoder.

7. The one or more processors of claim 1, wherein the one or more second decoder layers of the one or more language models support variable lengths of the contextual embedding corresponding to variable length contextual inputs.

8. The one or more processors of claim 1, wherein the one or more language models support multiple context encoders corresponding to different context modalities.

9. The one or more processors of claim 1, wherein the processing circuitry is further to select the first encoder from a plurality of supported context encoders based at least on the first encoder corresponding to a context modality represented by the contextual embedding.

10. The one or more processors of claim 1, wherein the processing circuitry is further to reconstruct the synthesized speech audio based at least on applying the representation of the synthesized speech audio to at least one of a neural codec decoder or a neural vocoder of the one or more language models.

11. The one or more processors of claim 1, wherein the contextual input represents at least one of an audio clip of a reference speaker, a textual description of the reference speaker, or an audio clip of a conversation history.

12. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-modal language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

13. A method comprising:
generating a representation of speech audio verbalizing input text based at least on cross-attending over a text embedding of the input text in one or more decoder layers of one or more language models independent of cross-attending over a contextual embedding of contextual input in one or more different decoder layers of the one or more language models.

14. The method of claim 13, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-modal language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

15. A system comprising:
one or more processors to control, within a simulation rendered using one or more light transport simulation algorithms, one or more operations of one or more simulated agents in a simulated environment based at least on one or more outputs of one or more language models comprising speech audio that verbalizes input text, the one or more outputs generated based at least on cross-attending over a text embedding of the input text in one or more decoder layers of the one or more language models independent of cross-attending over a contextual embedding of contextual input in one or more different decoder layers of the one or more language models.

16. The system of claim 15, wherein the simulation is generated, at least in part, using one or more content creation applications of a three-dimensional (3D) content collaboration platform for 3D assets.

17. The system of claim 16, wherein the simulated environment is represented in at least one content creation application of the one or more content creation applications using an OpenUSD format.

18. The system of claim 15, wherein the one or more operations comprise at least one of engaging in conversation, narrating one or more events, providing one or more instructions, or responding to one or more user actions within the simulation.

19. The system of claim 15, wherein the input text corresponds to at least one of one or more pre-written scripts, one or more responses to one or more events, or one or more contextual instructions corresponding to a state of the simulation.

20. The system of claim 15, wherein at least one language model of the one or more language models is implemented in at least one processing node of a plurality of processing nodes of a data center and accessible to one or more remote clients via at least one of an application programming interface (API), or an application plug-in.
